(19) United States
(12) Patent Application Publication
(10) Pub. No.: US 2002/0180170 A1
(43) Pub. Date: Dec. 5, 2002

(54) Shock controlled ladder bar system

(76) Inventor: Scott M. Anderson, Ribgy, ID (US)

Correspondence Address: ALAN J. HOWARTH, P.O. BOX 1909, SANDY, UT, 84091-1909, US

(21) Appl. No.: 10/164,101

(22) Filed: Jun. 4, 2002

Related U.S. Application Data
(60) Provisional application No. 60/295,970, filed on Jun. 5, 2001.

(51) Int. Cl. B60G 3/12

(52) U.S. Cl. 280/124.128

(57) ABSTRACT

A shock controlled ladder bar system illustratively includes a ladder bar connected to a vehicle frame through a shackle, for improving the traction capabilities of the vehicle. A shock absorber may also be connected to the shackle at one end and the vehicle frame at the opposing end. The shackle may be pivotally connected to the frame to allow the shackle to rotate and transfer loads from the ladder bar to the shock absorber, to thereby soften the ride of the vehicle. A locking pin may be used to lock the shackle in place with respect to the ladder bar and vehicle frame to more completely transfer forces from the ladder bar to the frame for obtaining improved traction during racing competitions. The locking pin may simply be removed from the shackle to allow forces from the ladder bar to be transmitted to the shock absorber once again for softer rides in traditional non-racing use.

### CROSS-REFERENCE TO RELATED APPLICATIONS

This application claims the benefit of U.S. Provisional Application No. 60/295,970, filed Jun. 5, 2001, which is hereby incorporated by reference in its entirety.

### STATEMENT REGARDING FEDERALLY SPONSORED RESEARCH OR DEVELOPMENT

Not Applicable.

### BACKGROUND OF THE INVENTION

The present invention relates generally to automotive accessories, and more particularly, but not necessarily entirely, to shock controlled devices for attaching ladder bars to vehicles.

There are many different types of suspension systems available for use in motor vehicles, such as the conventional leaf spring. In rear-wheel drive vehicles, during acceleration the leaf spring is subject to twisting forces which are opposite in direction and magnitude to the acceleration of the drive wheels. This tends to cause some wrap-up of the rear wheel leaf springs and, under extreme acceleration conditions, often contributes to rear wheel “hopping”. It is common practice to provide ladder bars in vehicles used in racing, to improve traction characteristics and also to control spring wrap, hopping and sway of the vehicles. Ladder bars are typically tubular structures attached at one end to the rear axle of the vehicle on opposite sides of the drive line. The front ends of the ladder bars are pivotally secured to the frame or chassis of the vehicle. The torque from the rear axle created during acceleration is transferred from the housing of the rear axle to the chassis of the vehicle by means of the ladder bars, thereby pushing the vehicle forward and preventing spring wrap and hopping. Ladder bars are relatively inexpensive to manufacture and install and are quite popular in the racing industry.

Despite the advantages of ladder bar systems, there are several disadvantages which reduce the desirability of ladder bars. For example, due to the rigid structural nature required for ladder bars, vehicles utilizing ladder bars may have a very rough and rigid ride. Therefore, the vehicles may not be suitable for both racing and traditional use on the street. Furthermore, installation of ladder bars is too difficult to make removal of the ladder bar system desirable so that the same vehicle could be used for both racing and traditional street use.

In view of the drawbacks inherent in the available art, it would be a significant advance in the art to provide a ladder bar system which provides shock absorbers to soften the ride of vehicles, and which is attractive in appearance. It would also be an advancement in the art to provide a shock controlled ladder bar system which is simple in design and manufacture, and which can easily be configured into a fixed arrangement for use in competition or a shock absorbing arrangement for traditional street use. It would be a further advancement in the art to provide such a shock controlled ladder bar system which maintains the capability of transferring torque from the vehicle axle to the vehicle frame to improve traction, prevent spring wrap and hopping, and which is adapted to be installed on a variety of different types of vehicles.

The present invention minimizes, and in some aspects eliminates, the above-mentioned failures, and other problems, by utilizing the methods and structural features described herein.

### BRIEF SUMMARY OF THE INVENTION

It is therefore an advantage of the present invention to provide a shock controlled ladder bar system that is simple in design and manufacture.

It is another advantage of the present invention to provide such a ladder bar system that provides shock absorbers to soften the ride of vehicles.

It is a further advantage of the present invention, in accordance with one aspect thereof, to provide a shock controlled ladder bar system that can easily be configured into a fixed arrangement for use in competition.

It is an additional advantage of the invention, in accordance with one aspect thereof, to provide a shock controlled ladder bar system that is capable of transferring torque from the vehicle axle to the vehicle frame to improve traction.

It is another advantage of the present invention to provide such a shock controlled ladder bar system that is adapted to be installed on a variety of vehicles.

It is a further advantage of the present invention to provide a shock controlled ladder bar system that is attractive in appearance.

The above advantages and others not specifically recited are realized in a specific illustrative embodiment of a shock controlled ladder bar system. The system illustratively includes a ladder bar connected to a vehicle frame through a shackle and a shackle mount, for improving the traction capabilities of the vehicle. A shock absorber may also be connected to the shackle at one end and the vehicle frame at the opposing end through a shock mount. The shackle may be pivotally connected to the frame to allow the shackle to rotate to transfer loads from the ladder bar to the shock absorber, and thereby soften the ride of the vehicle. A locking pin may be used to lock the shackle in place with respect to the ladder bar and vehicle frame to more completely transfer forces from the ladder bar to the frame for obtaining improved traction during racing competitions. The locking pin may simply be removed from the shackle to allow forces from the ladder bar to be transmitted to the shock absorber once again for softer rides in traditional non-racing use.

Additional advantages of the invention will be set forth in the description that follows, and in part will be apparent from the description, or may be learned by the practice of the invention without undue experimentation. The advantages of the invention may be realized and obtained by means of the instruments and combinations particularly pointed out in the appended claims.

### BRIEF DESCRIPTION OF THE DRAWINGS

The above and other features and advantages of the invention will become apparent from a consideration of the subsequent detailed description presented in connection with the accompanying drawings in which:

FIG. 1 is a break-away side view of the shock controlled ladder bar system of the present invention;

FIG. 2 is a break-away perspective view of the mounting assembly of the present invention;

FIG. 3 is a break-away perspective view of an alternative embodiment of the present invention;

FIG. 4 is a break-away side cross-sectional view of the alternative embodiment of FIG. 3;

FIG. 5 is a break-away side view of an additional alternative embodiment of the shock controlled ladder bar system of the present invention.

### DETAILED DESCRIPTION OF THE INVENTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

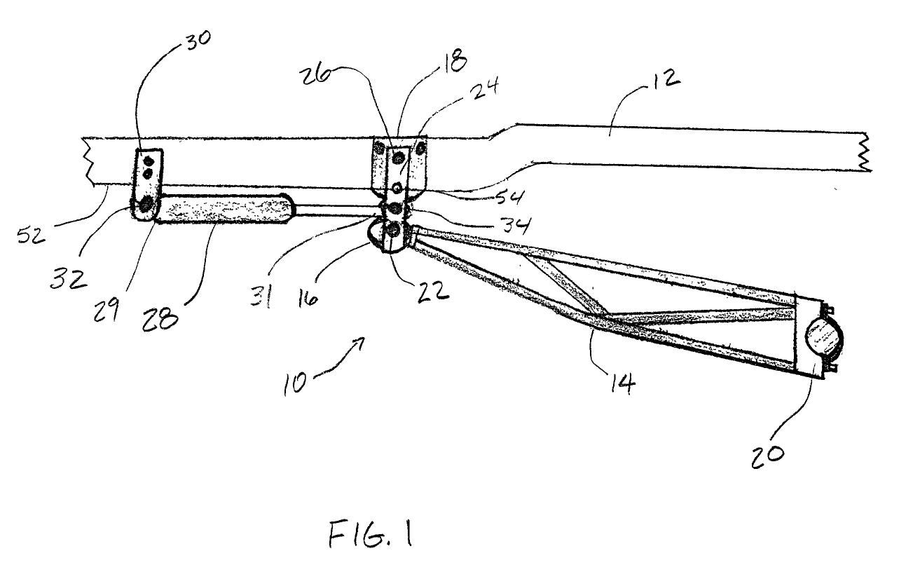

Referring now to FIG. 1, a break-away side view of the shock controlled ladder bar system of the present invention is shown, generally indicated at 10, attached to a vehicle frame 12. It will be appreciated that an identical shock controlled ladder bar system 10, may be located on the opposite side of the vehicle. The frame 12 may be part of the support structure for any variety of vehicles, such as cars or trucks, for which improved traction characteristics or control of spring wrap, hopping, and sway is desired. The shock controlled ladder bar system 10 may be seen on the underside of the vehicle to provide an attractive racing appearance.

Illustratively, a ladder bar 14 is attached at a first end 16 to the frame 12 through a frame shackle mount 18. A second end 20 of the ladder bar 14 is configured to be non-rotatably connected to an axle of the vehicle (not shown). The ladder bar 14 is illustratively connected to the frame shackle mount 18 through a ladder bar mount 22. The ladder bar mount 22 is illustratively constructed as a pivotal member such as a pin or bolt which allows the ladder bar 14 to rotate about the ladder bar mount 22. The ladder bar mount is illustratively connected to the frame shackle mount 18 by a shackle 24. A shackle pivot 26 is illustratively used to attach the shackle 24 to the frame shackle mount 18 so that the shackle 24 is allowed to rotate about the shackle pivot 26.

Illustratively, a shock absorber 28 is connected to the frame 12 at a forward end 29 by a shock mount 30. The shock absorber 28 may be of any variety known in the art for cushioning impacts such as by utilizing fluids or springs for example. The shock absorber 28 is illustratively mounted to the shock mount 30 through a forward shock pin 32 which allows the shock absorber to rotate with respect to the shock mount 30. An opposing rear end 31 of the shock absorber 28 is illustratively attached to the shackle 24 through a rear shock pin 34. The shock absorber 28 illustratively extends substantially parallel to the vehicle frame 12 to absorb impacts from the ladder bar 14 in a direction substantially parallel to the vehicle frame 12. However, forces exerted by the ladder bar 14 in a direction substantially perpendicular to the vehicle 12 frame are illustratively transmitted into the frame 12 by the shackle 24.

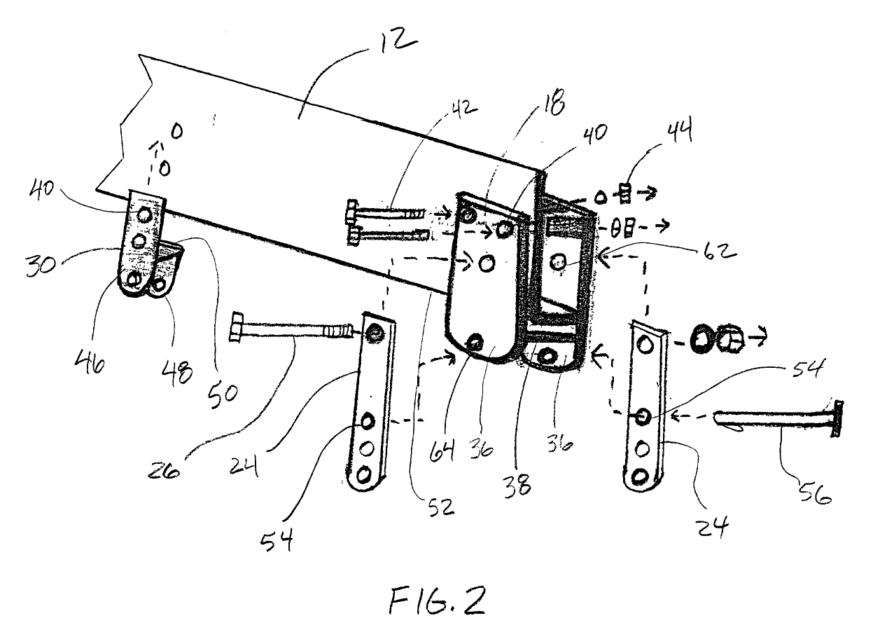

As illustrated most clearly in FIG. 2, an illustrative embodiment of the shackle mount 18 and the shock mount 30 is shown in a perspective view. The shackle mount 18 illustratively has two substantially identical vertical walls 36 which are spaced apart by a lateral brace 38 to fit around the vehicle frame 12. The vertical walls 36 illustratively include apertures 40 for receiving bolts 42 to attach the vertical walls 36 to the frame 12. Fasteners such as nuts 44 may be used to fix the bolts 42 in place and securely hold the vertical walls 36 to the frame 12.

The shock mount 30 also illustratively has apertures 40 for receiving bolts 42 to securely fasten the shock mount 30 to the frame 12. The shock mount 30 may not be required to support loads as great as those supported by the shackle mount 18. Thus, the shock mount 30 may be smaller and of lighter construction than the shackle mount 18. The shock mount 30 may include an attaching wall 46 and an opposing wall 48 separated by a connecting wall 50. The attaching wall 46 and the opposing wall 48 are illustratively configured to receive the forward shock pin 32 and the forward end 29 of the shock absorber 28.

It will be appreciated by those skilled in the art that the size and shape of the shackle mount 18 and the shock mount 30 are configured to attach to a typical frame 12 known in the industry, so that the shock controlled ladder system 10 may be installed on various different types of vehicles. It will also be appreciated that the shackle mount 18 and the shock mount 30 may be configured in different arrangements within the scope of the present invention. For example, the shackle mount 18 and the shock mount 30 may be configured in a channel shape to be attached to a bottom surface 52 of the vehicle frame within the scope of the present invention. Furthermore, it will be appreciated by those skilled in the art that the shackle mount 18 and the shock mount 30 may be attached to the frame 12 using other techniques besides the bolts 42 and nuts 44, such as by welding, within the scope of the present invention.

The shock controlled ladder bar system 10 of the present invention also illustratively includes an arrangement which allows the shackle 24 to be fixed in place so that added traction can be achieved during competitions such as races. The shackle 24 illustratively includes two substantially identical members positioned on opposite sides of the shackle mount 18, each including a pin hole 54, as shown most clearly in FIG. 2. The pin hole 54 is configured to receive a locking pin 56 to lock the shackle against rotation. When the locking pin 56 is inserted into the pin hole 54, the shackle 24 is held to the shackle mount 18 in two locations, at the shackle pivot 26, and at the locking pin 56. Thus, rotation of the shackle 24 with respect to the shackle mount 18 is prevented, and forces exerted on the shackle 24 by the ladder bar 14 are transferred to the vehicle frame 12. This transfer of forces increases the traction characteristics of the vehicle. When it is desired to improve the ride characteristics of the vehicle, such as in normal non-racing use, the pin 56 is simply removed from the pinhole 54. This allows the shackle 24 to pivot once again at the shackle pivot 26 to allow forces to be transferred from the ladder bar 14 to the shock absorber 28.

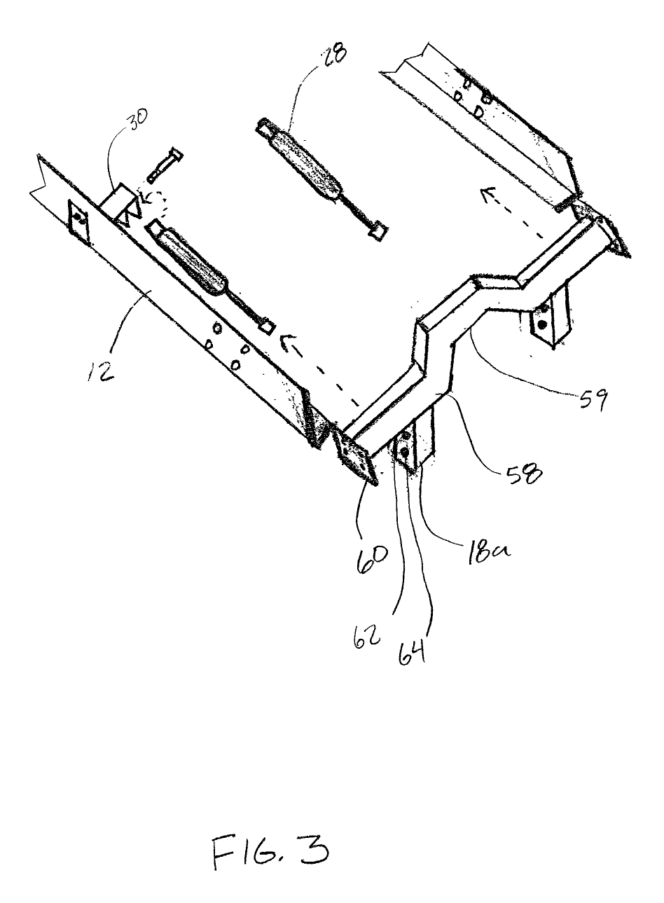

Reference will now to made to FIG. 3 to describe a second embodiment of the present invention. As previously discussed, the presently described embodiments of the invention illustrated herein are merely exemplary of the possible embodiments of the invention, including that illustrated in FIG. 3.

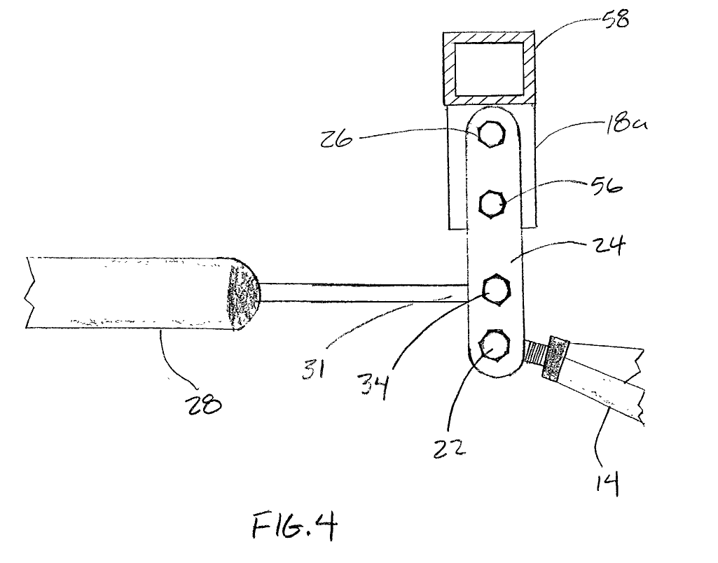

It will be appreciated that the second embodiment of the invention illustrated in FIG. 3 contains many of the same structures represented in FIGS. 1-2 and only the new or different structures will be explained to most succinctly explain the additional advantages which come with the embodiments of the invention illustrated in FIG. 3. The configuration of some vehicles may not allow the shock controlled ladder bar system to be installed in a manner as discussed above. Thus, the second embodiment of the invention includes a cross member 58 which allows the shock controlled ladder bar system to be installed closer to the center of the vehicle to avoid contact with vehicle components when necessary. The cross member 58 may be formed of a rigid structural member having an arch 59 configured to avoid contact with the vehicle drive line. The cross member 58 may have flanges 60 on opposing ends, with apertures 40 for receiving bolts to attach the cross member 58 to the frame 12. Illustratively, the cross member 58 also includes shackle mounts 18a having openings 62 for receiving the shackle pivot 26, and openings 64 for receiving the lock pin 56. As shown most clearly in FIG. 4, the shackle 24 may be attached to the shackle mount 18a through the shackle pivot 26. Furthermore, the shackle 24 may be fixed to the shackle mount 18a with lock pin 56 in a manner similar to the previous embodiment discussed above.

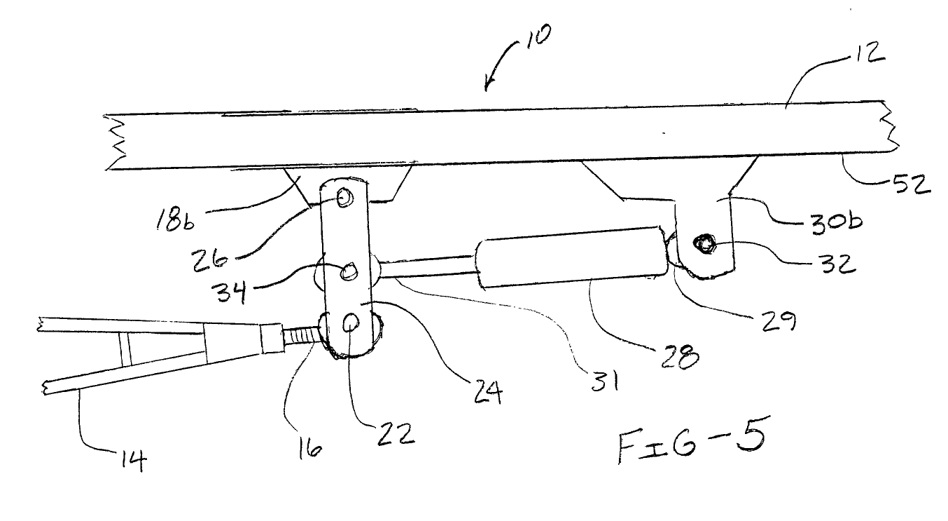

Reference will now to made to FIG. 5 to describe a third embodiment of the present invention. It will be appreciated that the third embodiment of the invention illustrated in FIG. 5 contains many of the same structures represented in FIGS. 1-4 and only the new or different structures will be explained to most succinctly explain the additional advantages that come with the embodiments of the invention illustrated in FIG. 5. The third embodiment of FIG. 5 illustratively includes a shackle mount 18b and a shock mount 30b which are configured to be attached to a bottom surface 52 of the frame 12. The shock mount 30b may have a widened portion on the side of the shock mount 30b closest to the frame 12 to assist in transferring forces from the shock mount 30b to the frame 12 without failure of the shock mount 30b. The shackle mount 18b and shock mount 30b may be attached to the frame 12 in any manner known to those skilled in the art, such as by bolts or welding for example. The third embodiment of the present invention allows the ladder bar system 10 to be attached to the frame 12 without accessing or interfering with the side of the frame 12.

In view of the foregoing, it will be appreciated that the present invention provides a ladder bar system which provides shock absorbers to soften the ride of vehicles, and which is attractive in appearance. The present invention also provides a shock controlled ladder bar system which is simple in design and manufacture, and which can easily be configured into a fixed arrangement for use in competition or a shock absorbing arrangement for traditional street use. Still further, the present invention provides a shock controlled ladder bar system which maintains the capability of transferring torque from the vehicle axle to the vehicle frame to improve traction, prevent spring wrap and hopping, and which is adapted to be installed on a variety of different types of vehicles.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and illustrative embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for improving the ride and traction characteristics of a vehicle, said system comprising:
a ladder bar for attaching to an axle of the vehicle;
a shock absorber for attaching to a frame of the vehicle; and
a shackle for connecting the ladder bar to both the frame of the vehicle and the shock absorber;
whereby the shackle is configured to transmit torque from the ladder bar to the frame of the vehicle to improve traction, and said shackle is further configured to transmit forces from said ladder bar to said shock absorber to soften the ride of the vehicle.

2. The system of claim 1 further comprising a shackle mount for attaching the shackle to the vehicle frame.

3. The system of claim 1 further comprising a shock mount for attaching the shock absorber to the vehicle frame.

4. The system of claim 2 further comprising a shackle pivot to pivotally attach the shackle to the shackle mount.

5. The system of claim 2 wherein the shackle mount and shackle further comprise openings for receiving a locking pin to lock the shackle with respect to the shackle mount.

6. The system of claim 2 wherein the shackle mount further comprises a pair of vertical walls separated by a lateral brace for surrounding said vehicle frame.

7. The system of claim 2 wherein said shackle mount is adapted to be attached to said vehicle frame by bolts.

8. The system of claim 2 wherein said shackle comprises a pair of members attached on opposing sides of said shackle mount.

9. The system of claim 1 wherein said ladder bar is attached to said shackle by a pivotal ladder bar mount.

10. The system of claim 1 wherein the shock absorber is attached to the shackle through a shock pin.

11. The system of claim 3 wherein the shock absorber is attached to the shock mount through a shock pin.

12. The system of claim 3 wherein the shock mount is adapted to be attached to the vehicle frame by bolts.

13. The system of claim 3 wherein said shock mount further comprises an attaching wall and an opposing wall for receiving said shock absorber therebetween.

14. The system of claim 1 wherein said shock absorber is arranged to be installed in an orientation substantially parallel to the vehicle frame.

15. The system of claim 1 wherein the shackle has a longitudinal dimension arranged to be substantially perpendicular to said vehicle frame.

16. The system of claim 1 further comprising a cross member for attaching said shackle to said vehicle frame, said cross member being configured to span opposing frame members on opposing sides of the vehicle.

17. The system of claim 16 wherein said cross member further comprises flanges for attaching the cross member to the vehicle frame.

18. The system of claim 16 wherein said cross member further comprises at least one shackle mount for attaching the shackle.

19. The system of claim 18 wherein said cross member comprises two shackle mounts spaced a distance from opposing ends of said cross member.

20. A system for absorbing forces exerted by a ladder bar, said ladder bar being affixed to an axle of a vehicle to improve traction capabilities of the vehicle, said system comprising:
a shackle for attachment to said ladder bar; and
a shock absorber attached to said shackle;
wherein said shackle is configured to transfer forces exerted by said ladder bar to a frame of said vehicle to improve traction capabilities of the vehicle, and said shackle is further configured to transfer forces exerted by said ladder bar to said shock absorber to allow the vehicle to have a softer ride.
